(19) United States
(12) Patent Application Publication
(10) Pub. No.: US 2007/0285424 A1
(43) Pub. Date: Dec. 13, 2007

(54) Generating annotation graphics in 2D form to model 3D elements

(75) Inventors: Xinsheng Cheng, Manchester, NH (US); Paul Fred DesSureault, Weare, NH (US); Jason Martin, Pembroke, NH (US)

Correspondence Address: PATTERSON & SHERIDAN, L.L.P., 3040 POST OAK BOULEVARD, SUITE 1500, HOUSTON, TX, 77056, US

(73) Assignee: Autodesk, Inc.

(21) Appl. No.: 11/451,732

(22) Filed: Jun. 12, 2006

(51) Int. Cl. G06T 15/20

(52) U.S. Cl. 345/427; 345/624

(57) ABSTRACT

A model-based design system couples intelligent 3D model elements with an analytical model that describes fluid flow through the 3D model. The system automatically generates annotation graphics for a 2D view of the elements with respect to a view plane. The system displays a drop symbol when the elements are below the view plane and the system displays a rise symbol when the elements penetrate and rise above the view plane. In addition to the rise/drop indications, the annotation graphics may indicate the type of service provided by the elements and the location and direction of flow. Advantageously, the system generates these annotation graphics automatically from 3D model and the analytical model.

### BACKGROUND OF THE INVENTION

1. Field of the Invention

The present invention generally relates to computer graphics and applications, graphical user interfaces, and computer simulation and modeling. More specifically, the present invention relates to a computer-aided design (CAD) system for generating annotation graphics in two-dimensional (2D) form that model three-dimensional (3D) elements.

2. Description of the Related Art

The term computer-aided design (CAD) generally refers to a broad variety of computer-based design tools used by architects, engineers, and other construction and design professionals. CAD systems allow users to create, manage, and share design data with integrated design and data management tools. Some CAD systems allow users to construct 3D models representing virtually any real-world construct, such as homes, offices, and other buildings. These CAD systems typically generate a variety of 2D and 3D views on a computer display, such as plan, profile, section, and elevation views. CAD systems can provide design and construction documentation for mechanical, electrical, and plumbing (MEP) engineers as well as for architects, structural engineers, and others to improve productivity, accuracy, and coordination between design and construction teams.

Some CAD systems provide building information modeling (BIM). BIM is the creation and use of coordinated, internally consistent, computable information about the design and construction of a building project. BIM includes parametric change management. The term parametric refers to the relationships among and between all the elements of a model that enable coordination and change management. These relationships may be created automatically by the CAD system software or deliberately by a designer as the designer works. BIM coordinates changes and maintains consistency at all times so that the user does not have to intervene to update drawings or links. When a designer changes something, the CAD system software automatically applies that change to any affected elements.

CAD systems may maintain various kinds of information related to building design and construction, including mechanical duct and pipe systems modeling, electrical lighting and power circuitry, electrical lighting calculations, plumbing system modeling, building support, structure support, and heating, ventilation, and air-conditioning (HVAC) energy and load analysis, and the like. In the development and drafting of piping and/or HVAC systems, an important element of design and construction drawings are annotation graphics in 2D form to model 3D elements. These annotation graphics help, for example, installers understand the location and service provided by system elements. Manually creating these annotation graphics is a time-consuming and error-prone process. Much time may be lost reformatting a set of drawings or updating numerous annotations manually. An engineer or draftsperson typically wastes time performing tedious updating tasks and sometimes makes costly coordination errors. For piping and/or HVAC systems, manual tasks might include identifying which elements are intakes and outlets, adding appropriate annotation graphics and adding trace connecting elements. Conventional CAD systems are unable to automate such tasks due to the lack of native intelligence in the CAD system software regarding the way fluid/air moves through the system and the connections between elements, among other information.

Accordingly, design and construction professionals need a CAD system to eliminate the time that is currently spent manually reformatting and updating all the annotation graphics. This would minimize tedious updating tasks and costly coordination errors.

### SUMMARY OF THE INVENTION

The present invention is directed to methods and computer program products that minimize tedious updating tasks and costly coordination errors by automatically generating an annotation graphic in 2D form to model a 3D element in a CAD system. One embodiment of the invention is a method for generating an annotation graphic in 2D form to model a 3D element. A CAD system automatically generates the annotation graphic of a particular element in 2D form based on both a 3D model of the element and the position of a 2D view plane with respect to the element. The annotation graphic indicates whether the element is below the 2D view plane or rises above the 2D view plane. The method may further include displaying the generated annotation graphic. The annotation graphic may also indicate the service type for the element and/or the direction of flow for the element based on information in an analytical model that is associated with or part of the 3D model. The elements may represent piping elements, ductwork elements, plumbing elements, or any other kind of elements.

Another embodiment is a method for viewing an annotation graphic in 2D form that models a 3D element. While viewing an element in a 3D model, the user selects a position or location of a 2D view plane in relation to the element. Then, the user is able to view an annotation graphic representing the element in a 2D view based on the 3D model. The annotation graphic indicates whether the element is below or rises above the selected 2D view plane. The annotation graphic may also indicate the service type for the element and/or the direction of flow for the element based on information from an analytical model that is associated with or part of the 3D model. The elements may represent piping elements, ductwork elements, plumbing elements, or any other kind of elements.

Advantageously, by automatically generating annotation graphics, the CAD system eliminates the time users currently spend manually reformatting and updating all the annotations. This minimizes tedious updating tasks and costly coordination errors.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only exemplary embodiments of this invention and are therefore not to be considered limiting of its scope, for the claimed invention may admit to other equally effective embodiments.

FIG. 1 is a 2D view of an exemplary ductwork design, according to one embodiment of the present invention.

FIG. 2 is a 3D view of the exemplary ductwork design of FIG. 1, according to one embodiment of the present invention.

FIG. 3 is 3D view of an exemplary 2D view plane, according to one embodiment of the present invention.

FIG. 4 is a 2D view of another exemplary ductwork design, according to one embodiment of the present invention.

FIG. 5 is a 3D view of the exemplary ductwork design of FIG. 4, according to one embodiment of the present invention.

FIG. 6 is a 2D view of an exemplary mechanical floor plan design according to one embodiment of the present invention.

FIG. 7 is a 2D elevation view of another ductwork design, which 3D model elements from the side, according to one embodiment of the present invention.

FIG. 8 is a graphical user interface window for an exemplary symbol selection feature according to one embodiment of the present invention.

FIG. 9 is a block diagram of a networked computer environment in which systems and methods according to embodiments of the present invention may be implemented.

FIG. 10 is a flow chart of an exemplary method of generating an annotation graphic in 2D form to model a 3D element according to one embodiment of the present invention.

### DETAILED DESCRIPTION OF THE PREFERRED EMBODIMENTS

One exemplary embodiment is a CAD system that generates an annotation graphic in 2D form to model a 3D element. The CAD system couples intelligent 3D model elements with an analytical model that describes, for example, fluid/air flow through the 3D model. The CAD system automatically generates annotation graphics based on information associated with the models, such as the service that the elements provide and the relationship between the elevation of the elements and the 2D view plane. However, embodiments of the invention are not limited to any particular kind of CAD system, 3D models, analytical models, service, or graphical symbols. Although the detailed description includes graphical representations for piping elements, ductwork elements, and plumbing elements, the present invention applies to representations of virtually any real-world construct, such as electrical, mechanical, architectural, or structural elements, or and other kind of design or construction elements for homes, offices, and other buildings or structures.

### Relationship of 2D and 3D Views

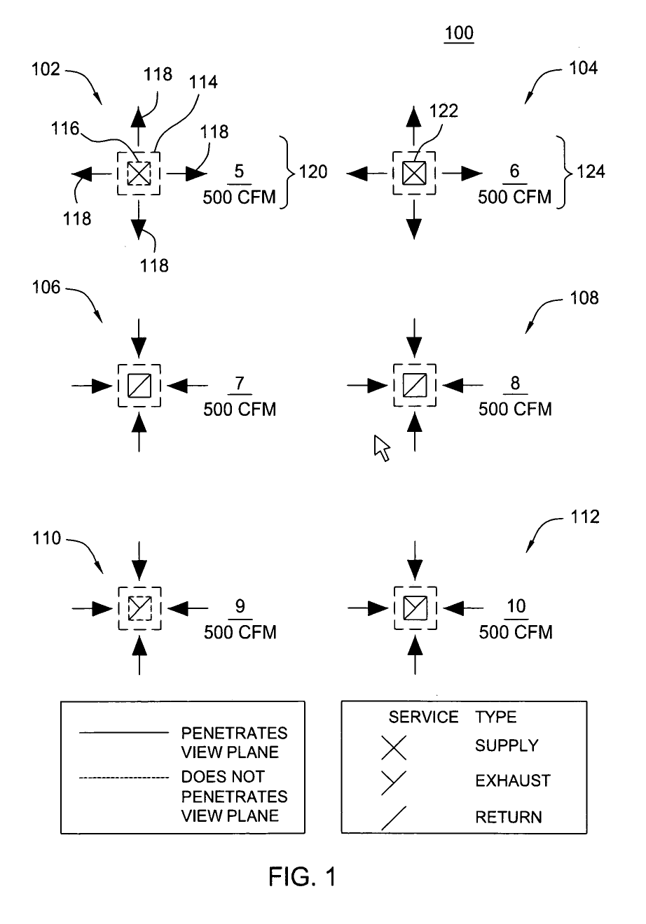

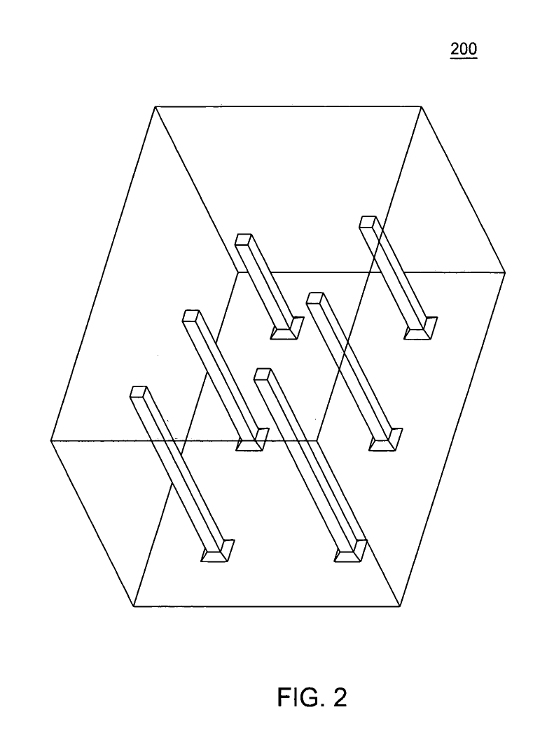

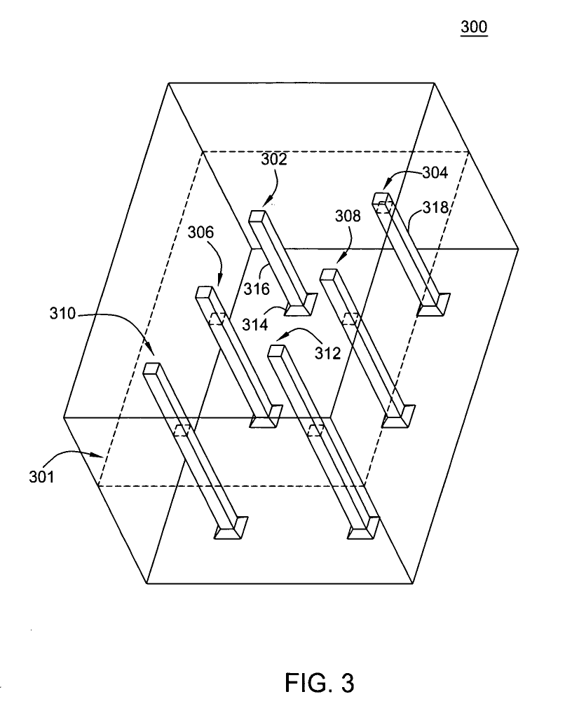

FIGS. 1-3 are related views of an exemplary ductwork design according to one embodiment of the present invention. FIG. 2 shows a 3D view 200 of a 3D model for display in a CAD system. FIG. 3 shows a different 3D view 300 to illustrate the position or location of a 2D view plane 301 in the 3D model. Selection of this 2D view plane 301 helps create a point of view for a 2D view of the 3D model. FIG. 1 shows the 2D view 100 that is the slice created when the 2D view plane 301 penetrates through the 3D model. The 2D view 100 is a top view looking down on the slice created by the 2D view plane 301. In one embodiment, a 3D view shows the 2D view plane 301 with shading or color or as a translucent or dashed plane. In another embodiment, entering an elevation value establishes the 2D view plane, but the 2D view plane itself is not displayed in any 3D view.

### Annotation Graphics

Comparing FIGS. 1 and 3, the 2D view 100 in FIG. 1 shows annotation graphics 102, 104, 106, 108, 110, 112 that represent corresponding elements 302, 304, 306, 308, 310, 312 in the 3D view 300 shown in FIG. 3. The elements in the 3D view 300 are part of the exemplary ductwork design. In this example, the ductwork design includes air terminals and ducts related to supply systems, exhaust systems, and return systems.

Annotation graphic 102 represents a vertical duct connected to an air terminal (or diffuser) coming out of the page and running vertically from the air terminal on the floor to the ceiling. Comparing element 302 in FIG. 3, one can see that element 302 includes an air terminal 314 connected to a duct 316 represented by annotation graphic 102. The annotation graphic 102 includes an outer dashed rectangle 114 (FIG. 1), which represents the air terminal 314 (FIG. 3), and an inner dashed rectangle 116 (FIG. 1), which represents the duct 316 (FIG. 3) that is connected to the air terminal 314 and runs vertical to an elevation of 5 feet. The “X” inside the inner dashed rectangle 116 indicates a supply system (i.e., the service type is supplying air to the room). The arrows 118 adjacent to the outer dashed rectangle 114 indicate that air is flowing out from the air terminal 314. The annotation graphic 102 further indicates with text 120 that the elevation is 5 feet and the airflow rate is 500 cubic feet per minute (cfm). In this example, the CAD system automatically determines the airflow rate for a particular element using connectivity information in the 3D model and data in the analytical model. Other embodiments may include various other calculations or engineering data, depending on the desired analysis. Other embodiments may represent various characteristics of elements in various different ways, for example, using different symbols, shading, color, line thicknesses, etc.

### Indicating Rising Above or Falling Below a View Plane

Annotation graphic 104 differs in two ways from annotation graphic 102. First, Annotation graphic 104 has an inner solid rectangle 122, as opposed to the dashed inner rectangle 114 of annotation graphic 102. In this 2D representation, solid lines indicate that the 3D element penetrates the view plane and dashed lines indicate that the element does not penetrate the view plane. Comparing FIGS. 1 and 3, the inner rectangle 122 is solid, because it corresponds to the duct 318 for element 304 in the 3D view 300. Duct 318 rises above the 2D view plane 301 and, thus, penetrates the view plane. The second difference between annotation graphics 104 and 102 relates to text 120 and 124. The text 124 for annotation graphic 104 indicates that the corresponding duct 318 rises to an elevation of 6 feet, while annotation graphic 102 represents shorter duct 316, rising to only 5 feet. The shorter duct 316 is below the 2D view plane 301 (e.g., at an elevation of 5.5 feet) and, thus, is represented in 2D form by dashed inner rectangle 114 of annotation graphic 102. Other embodiments may represent rising above or falling below the view plane in other ways, for example, using different symbols (e.g., a drop symbol and a rise symbol), shading, color, line thicknesses, etc. Another embodiment may also indicate when the element is at the same elevation as the view plane.

### Indicating Service Type

Although the three annotation graphics 102, 110, and 106 appear similar, their centers are different. The centers indicate the type of service provided by the 3D elements (FIG. 3) represented in the 2D view 100 (FIG. 1). The “X” in the center of annotation graphic 102 indicates a supply system. A supply system supplies air to a room. The “Y” in the center of annotation graphic 110 indicates an exhaust system. An exhaust system moves air out of the room and vents it to the outside of the building. The “/” in the center of annotation graphic 106 indicates a return system. A return system takes air out of the room for reconditioning and then moves the reconditioned air back into the room. In this example, the CAD system automatically determines how to display a particular element using properties of the element or its connected elements, which include a service type. Other embodiments may represent none or various other properties and characteristics associated with particular elements. In one embodiment, which properties are represented varies, depending on one or more properties associated with each element.

In FIG. 1, arrows indicate the direction of airflow. For example, annotation graphic 102 represent a supply system (“X”), which supplies air to a room. Accordingly, annotation graphic 102 represents air moving out from air terminal 314 with arrows adjacent to the outer dashed rectangle 114. In other embodiments, annotation graphics need not include such arrows. Of course, other embodiments may indicate various other optional properties and characteristics.

### Indicating Connected Elements

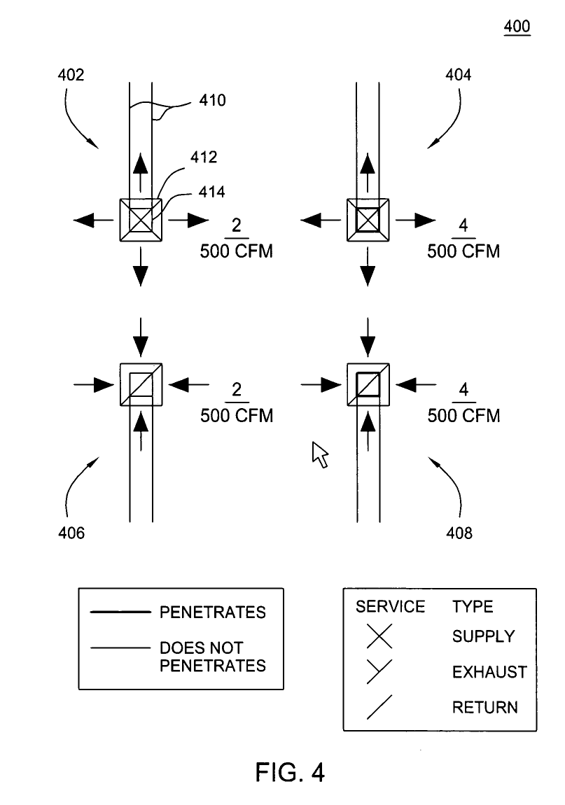

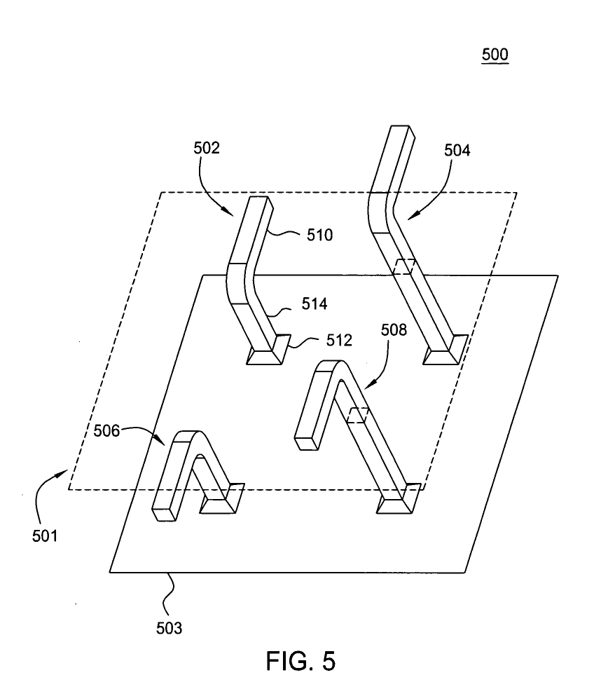

FIGS. 4 and 5 are related views of a different exemplary ductwork design than FIGS. 1-3, according to one embodiment of the present invention. FIG. 4 shows a 2D view 400 of the exemplary ductwork design, while FIG. 5 shows a 3D view 500 of the same design. This example ductwork design has fewer elements and includes vertical ducts connected by elbows to horizontal ducts.

FIG. 4 is a 2D view 400 that shows annotation graphics 402, 404, 406, and 408 representing elements in 2D form that model 3D elements 502, 504, 506, and 508 respectively in FIG. 5. In addition to indicating air terminals and vertical ducts with rectangles, the annotation graphics in FIG. 4 indicate the horizontal ducts connected to the elements. For example, annotation graphic 402 includes lines 410 indicating horizontal duct 510 (FIG. 5) in addition to the rectangles 412, 414 indicating air terminal 512 and vertical duct 514 respectively. In this example, line thickness indicates whether an element is above or below 2D view plane 501, rather than dashed or solid lines, as in FIGS. 1-3. A rectangle with thick lines, as in annotation graphics 404, 408, indicates that the corresponding vertical duct rises above the 2D view plane 501. Another difference is that the service type (e.g., “X”) is indicated within the outer rectangles, rather than within the inner rectangles, as in FIGS. 1-3. This illustrates that annotation graphics may represent various different properties and characteristics of 3D elements in 2D form in different ways and the present invention is not limited to any particular way.

### Floor Plans

FIG. 5 is a 3D view 500 of the exemplary ductwork design. CAD systems commonly provide floor plans printouts for design and construction projects. Suppose 2D view plane 501 is the second floor and plane 503 is the first floor of a multiple-floor building. Elements 504 and 508 penetrate 2D view plane 501, while elements 502 and 506 do not penetrate the 2D view plane 501. This indicates that elements 504 and 508 rise above the second floor, while elements 502 and 506 are between the first and second floor. The floor plans are printouts of 2D views, such as 2D view 400 of FIG. 4 (e.g., the first floor). Because the annotation graphics on the first floor plan indicate that some elements rise above the ceiling into the second floor, the reader need not check a 3D model and knows to check the second floor plan for the continuation of those elements. Embodiments of the present invention include both annotation graphics for display and printed annotation graphics. Other embodiments include annotation graphics stored in memory and the like.

### Changes Propagated

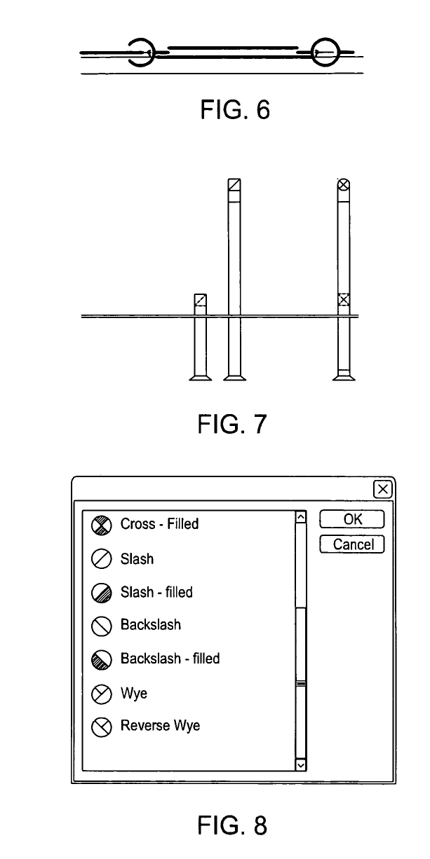

FIG. 6 is a 2D view of an exemplary mechanical floor plan design according to one embodiment of the present invention. FIG. 6 shows annotation graphics for a piping system that includes a radiator on a wall with pipe. In this example, pipe that does not penetrate a view plane is displayed as a semicircle, while pipe that penetrates the view plane is displayed as a circle. Other embodiments may indicate penetration of the view plane differently. Suppose a designer were to make a change, such as connecting another pipe to one of the pipes or changing the location or position of one of the pipes. When a designer changes an element of a 3D model, the CAD system automatically updates any 2D views. The CAD system automatically generates annotation graphics by propagating changes in properties and characteristics to all the elements connected to the changed element and determining a view range. Two planes, e.g., a floor and a view plane, define the view range. The CAD system may also update an analytical model and generate updated analysis information (e.g., water pressure) for display as text in a 2D view.

### Elevation Views

FIG. 7 is a 2D elevation view of another ductwork design, which 3D model elements from the side, according to one embodiment of the present invention. Dashed lines indicate that an element does not penetrate a vertical (rather than horizontal) view plane, while solid lines indicate that the element penetrates the vertical view plane. A solid line indicates that a ductwork element penetrates the vertical view plane and a dashed line indicates that a ductwork element does not penetrate the vertical view plane. For piping, a semicircle indicates that a piping element penetrates the view plane and a circle indicates that a piping element does not penetrate the view plane. Other embodiments may represent penetration of the view plane in the same way for all types of elements. In addition, other embodiments may represent penetration of the view plane in other ways, for example, using different symbols (e.g., rise symbol, drop symbol), shading, color, line thicknesses, etc.

Signifying elevation in a 2D view is useful, because elements of a 3D model may be hidden behind surfaces. 2D building plans in elevation views for builders are easier to read and do not have hidden elements. Usually a 3D model of a building is used to generate floor plans in printable 2D views. When a contractor sees an annotation graphic on a 2D view, the contracted can immediately tell from the annotation graphics, for example, that it is a duct or pipe running vertically to a particular elevation so that they can make allowances in the slab they are pouring so that it will hold. The annotation graphics also connect one floor plan sheet to the next floor plan sheet, when, for example the annotation graphic indicates that a duct on the first floor, for example, extends up into the second floor.

### User-Defined Symbols

FIG. 8 is a graphical user interface window for an exemplary symbol selection feature according to one embodiment of the present invention. The particular symbols or indications used in the annotation graphics may vary and CAD system users may edit or configure them in some embodiments. In one embodiment, the user can associate different symbols or annotation graphics for different types of elements or different properties or characteristics of elements using a graphical user interface, as illustrated in FIG. 8.

### CAD System

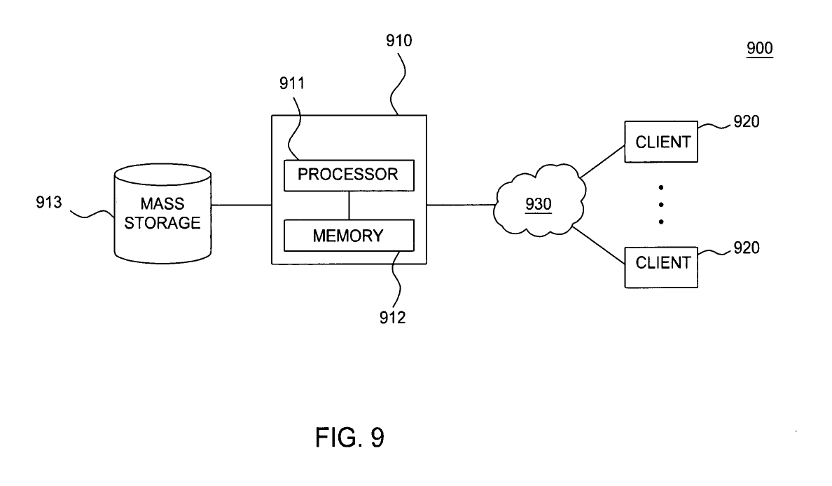

FIG. 9 is a block diagram of a computer environment 900 in which systems and methods according to embodiments of the present invention may be implemented. One embodiment of the computer environment 900 includes a computer 910 (e.g., personal computer (PC)) programmed as a standalone, single workstation operating the CAD system and having conventional output devices, such as a computer display or a printer for generating the annotation graphics in 2D form.

Another embodiment of the computer environment 900 includes a server computer 910 and a number of client computers 920 (only two of which are shown). A computer network 930 (e.g., a local area network (LAN)) connects the server computer 910 and the client computers 920. The components of the server computer 910 that are illustrated in FIG. 9 include a processor 911 and a system memory 912. The server computer 910 is connected to a mass storage unit 913 that stores the contents managed by the server computer 910. Each client computer 920 includes conventional components of a computing device, e.g., a processor, system memory, a hard disk drive, input devices, such as a mouse and a keyboard, and output devices, such as a monitor (not shown). In this embodiment, the server computer 910 is programmed to operate as a network server that communicates with the client computers 920.

In another embodiment, the server computer 910 is programmed as a web server that communicates with the client computers 920 using the TCP/IP protocol, and hosts a web site that can be accessed by the client computers 920. The client computers 920 are programmed to execute client programs to access the CAD system as a service provided by the server computer 910. The server computer 910 manages the content stored in the mass storage unit 913 using a database management system. The contents include elements of CAD drawings, designs, 3D models, and 2D views, analytical models, engineering data, such as fluid flow, and other data.

### Generating Annotation Graphics

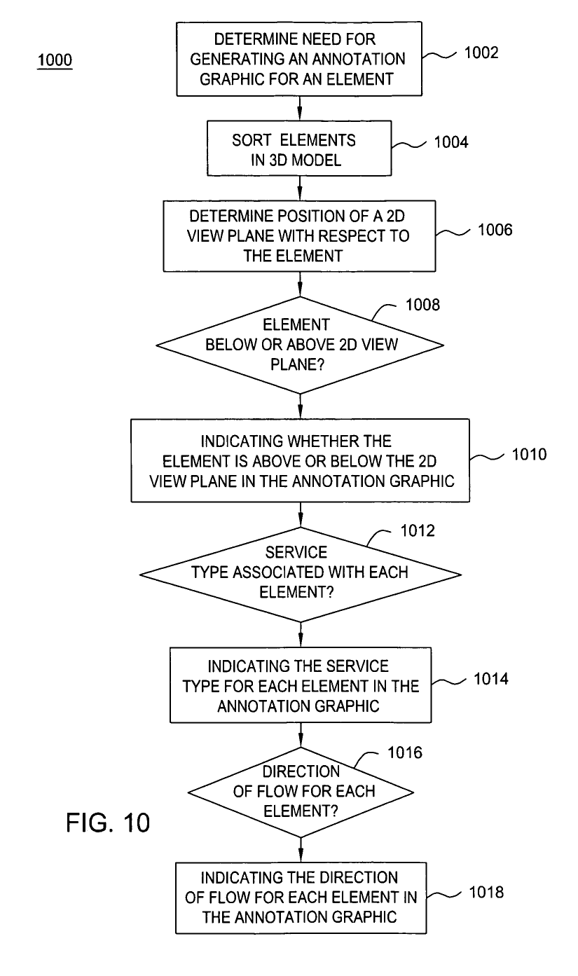

FIG. 10 is a flow chart of an exemplary method 1000 of generating an annotation graphic in 2D form to model a 3D element according to one embodiment of the present invention. At 1002, The CAD system determines whether there is any need to generate annotation graphics for one or more elements. Typically, a user selects a particular view or changes the model in some way that creates the need. Before creating the view, the CAD system sorts all the elements in the 3D model at 1004 to determine which elements are within a view range associated with the view. Two planes, e.g., the view plane and a floor, define the view range. Then, the CAD system automatically generates appropriate annotation graphics for each element in the view range using information (e.g., service type, elevation, connected elements, air/water flow) associated with each element. At 1006, the CAD system determines the position of the view plane in relation to each element and whether it is above or below the view plane at 1008 and generates the appropriate annotation graphics at 1010. At 1012, the CAD system determines the service type associated with each element and generates the appropriate annotation graphic at 1014. At 1016, the CAD system optionally determines the direction of flow for each element and generates the appropriate annotation graphic at 1018.

In another embodiment of the method 1000, the CAD system determines all the various properties and characteristics of each element, before generating the annotation graphics for the element. Of course, the present invention may be embodiment in various ways. In one embodiment, the CAD system generates and stores a 2D view comprising all of the annotation graphics for all of the elements in memory or a buffer so that the 2D view is available for display. In one embodiment, an annotation graphic for an element comprises other annotation graphics. In one embodiment, the annotation graphics for an element include indications for various properties and characteristics of each element. In one embodiment, some of the indications are optional. In one embodiment, the annotation graphics comprise a set of symbols, such as rise/drop symbols or service type symbols. In one embodiment, the annotation graphics are user-selectable. In one embodiment, the annotation graphics for display in a 2D view are different in some respects (e.g., color, shading, symbols, or lack of optional information) from the annotation graphics for printed floor plans. In one embodiment, the annotation graphics include information from an analytical model that describes fluid flow through the elements in the 3D model of the design. In one embodiment, the method 1000 is stored as a compute program product or as instructions on a computer readable medium, such as a compact disk (CD).

While particular embodiments according to the invention have been illustrated and described above, those skilled in the art understand that the invention can take a variety of forms and embodiments within the scope of the appended claims.

What is claimed is:

1. A method for generating an annotation graphic in two-dimensional (2D) form to model a three-dimensional (3D) element, comprising:
automatically generating an annotation graphic of an element in 2D form based on a 3D model of the element and a position of a 2D view plane with respect to the element, the annotation graphic indicating whether the element is below the 2D view plane or rises above the 2D view plane.

2. The method of claim 1, further comprising:
displaying the generated annotation graphic.

3. The method of claim 1, wherein the annotation graphic indicates a service type for the element.

4. The method of claim 1, wherein the annotation graphic indicates a direction of flow for the element based on an analytical model associated with the 3D model.

5. The method of claim 1, wherein the elements are piping elements.

6. The method of claim 1, wherein the elements are ductwork elements.

7. The method of claim 1, wherein the elements are plumbing elements.

8. A computer-readable medium containing a program which when executed by a processor, performs a method for generating an annotation graphic in two-dimensional (2D) form to model a three-dimensional (3D) element, the method comprising:
automatically generating an annotation graphic of an element in 2D form based on a 3D model of the element and a position of a 2D view plane with respect to the element, the annotation graphic indicating whether the element is below the 2D view plane or rises above the 2D view plane.

9. The computer-readable medium of claim 8, further comprising:
displaying the generated annotation graphic.

10. The computer-readable medium of claim 8, wherein the annotation graphic indicates a service type for the element.

11. The computer-readable medium of claim 8, wherein the annotation graphic indicates a direction of flow for the element based on an analytical model associated with the 3D model.

12. The computer-readable medium of claim 8, wherein the elements are piping elements.

13. The computer-readable medium of claim 8, wherein the elements are ductwork elements.

14. The computer-readable medium of claim 8, wherein the elements are plumbing elements.

15. A method for viewing an annotation graphic in two-dimensional (2D) form that models a three-dimensional (3D) element, comprising:
viewing an element in a 3D model;
selecting a position of a 2D view plane with respect to the element;
viewing an annotation graphic of the element in 2D form based on the 3D model, the annotation graphic indicating whether the element is below the 2D view plane or rises above the 2D view plane.

16. The method of claim 15, wherein the annotation graphic indicates a service type for the element.

17. The method of claim 15, wherein the annotation graphic indicates a direction of flow for the element based on an analytical model associated with the 3D model.

18. The method of claim 15, wherein the elements are piping elements.

19. The method of claim 15, wherein the elements are ductwork elements.

20. The method of claim 15, wherein the elements are plumbing elements.
